(19) United States
(12) Patent Application Publication
(10) Pub. No.: US 2017/0307085 A1
(43) Pub. Date: Oct. 26, 2017

(54) CIRCUMFERENTIAL SHAFT SEAL WITH RADIAL DISPLACEMENT CONTROL

(71) Applicant: George Perry Haynes, Baltimore, MD (US)

(72) Inventor: George Perry Haynes, Baltimore, MD (US)

(73) Assignee: KAYDON RING & SEAL , INC., Baltimore, MD (US)

(21) Appl. No.: 15/136,118

(22) Filed: Apr. 22, 2016

(51) Int. Cl. F16J 15/26

(52) U.S. Cl. CPC F16J 15/26

(57) ABSTRACT

A circumferential seal assembly for sealing about a rotatable shaft includes two or more generally arcuate bodies coupleable together to form a generally annular seal disposeable about a shaft outer surface. Each arcuate body has opposing female and male circumferential ends. Each female end includes a recess defined between a radially-inner arm and a radially-outer arm each extending generally circumferentially from a remainder of the arcuate body. Each male end includes a projection extending circumferentially from the remainder of the arcuate body and is sized to be disposeable within the recess of an adjacent arcuate body to couple the arcuate body with the adjacent arcuate body. Further, the female end inner arm of each arcuate body is disposed radially between the shaft outer surface and at least a portion of the male end projection of the adjacent arcuate body when the arcuate body is coupled with the adjacent arcuate body.

### BACKGROUND OF THE INVENTION

The present invention relates to seals, or more particularly to contact circumferential seals for sealing about rotatable shafts.

Contact circumferential shaft seals are known and typically include one or more arcuate segments connected together to form an annular seal body, which is often formed of carbon graphite, ceramic, a polymer, etc. The seal body has an inner circumferential surface that contacts the shaft outer surface to form a seal, which is generally the axial width of the seal body and thus having a relatively larger sealing surface than many other types of shaft seals, such as a radial lip seal. In many applications, circumferential contact seals are configured as gas film seals including one or more “lift” recesses to generate a lifting force that displaces the seal body generally radially to minimize contact with the shaft outer surface.

### SUMMARY OF THE INVENTION

In one aspect, the present invention is a circumferential shaft seal assembly for sealing about a rotatable shaft, the shaft having an outer circumferential surface. The seal assembly comprises at least two generally arcuate bodies coupleable together to form a generally annular seal disposeable about the shaft outer surface, each arcuate body having opposing female and male circumferential ends. Each female end includes a recess defined at least partially by a radially-inner arm and a radially-outer arm each extending generally circumferentially from a remainder of the arcuate body. Each male end includes a projection extending circumferentially from the remainder of the arcuate body and is sized to be disposeable within the recess of an adjacent arcuate body to couple the arcuate body with the adjacent arcuate body. Further, the female end inner arm of each arcuate body is disposed radially between the shaft outer surface and at least a portion of the male end projection of the adjacent arcuate body when the arcuate body is coupled with the adjacent arcuate body.

In another aspect, the present invention is again a circumferential shaft seal assembly for sealing about a rotatable shaft, the shaft having an outer circumferential surface. The seal assembly comprises a generally annular body having female and male circumferential ends coupleable together to form a generally continuous seal body. The female end includes a recess defined at least partially by a radially-inner arm and a radially-outer arm each extending generally circumferentially from a remainder of the arcuate body. The male end includes a projection extending circumferentially from the remainder of the arcuate body and is sized to be disposeable within the female end recess. The female end inner arm is disposed radially between the shaft outer surface and at least a portion of the male end projection when the two body ends are coupled together such that the inner arm is configured to generally prevent radially-inward displacement of the male end.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view partially in perspective of a seal assembly in accordance with the present invention;

FIG. 2 is side plan view of an arcuate body of the seal assembly;

FIG. 3 is a perspective view of the arcuate body of FIG. 2;

FIG. 4 is a perspective view of a plurality of seal arcuate bodies coupled together to form a seal;

FIG. 5 is an enlarged, broken-away, perspective view of a joint formed between a seal arcuate body and an adjacent arcuate body;

FIG. 6 is an enlarged, broken-away perspective view from an inner side of a female end of a seal arcuate body;

FIG. 7 is an enlarged, broken-away perspective view from an outer side of the female end of a seal arcuate body;

FIG. 8 is an enlarged, broken-away perspective view from an inner side of a male end of a seal arcuate body;

FIG. 9 is an enlarged, broken-away perspective view from an outer side of the male end of a seal arcuate body;

FIG. 10 is a side plan view of a joint showing an alternative construction of the male and female ends;

FIG. 11 is a broken-away, perspective view of the male end of the alternative construction joint shown in FIG. 10;

FIG. 11 is a broken-away, perspective view of the female end of the alternative construction joint shown in FIG. 10;

FIG. 13 is an exploded view of one preferred application of the seal assembly;

FIG. 14 is a broken-away, perspective view in partial axial cross-section of the preferred application of the seal assembly; and

FIG. 15 is an alternative construction of a seal body formed as a single piece.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

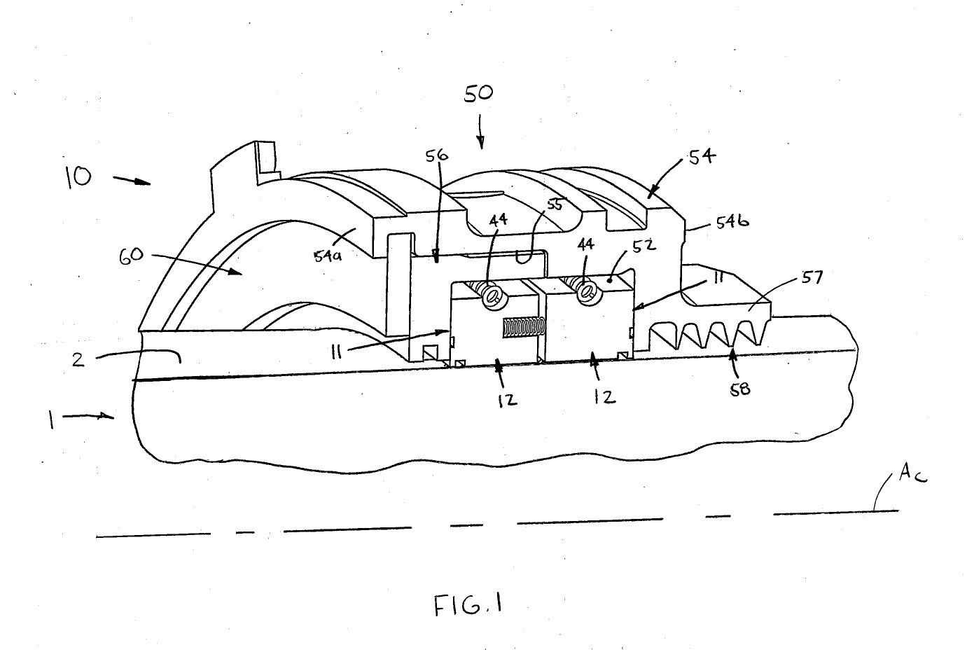

Referring now to the drawings in detail, wherein like numbers are used to indicate like elements throughout, there is shown in FIGS. 1-14 a first construction of a circumferential shaft seal assembly 10 for sealing about a rotatable shaft 1 (FIG. 1), the shaft 1 having an outer circumferential surface 2 and a central axis of rotation A_{C}. The seal assembly 10 basically comprises at least two and preferably a plurality of generally arcuate bodies 12 spaced circumferentially about the shaft axis A_{C} and coupleable/coupled together to form a generally annular seal 11 disposeable about the shaft outer surface 2. Each arcuate body 12 has a female circumferential end 14 and an opposing male circumferential end 16 and is preferably formed of carbon, carbon graphite, ceramic, a ceramic-carbon mixture, a polymer and/or a ferrous metal. The female end 14 of each body 12 includes a recess 18 defined at least partially by a radially-inner arm 20 and a radially-outer arm 22, each arm 20, 22 extending generally circumferentially from a remainder of the arcuate body 12. Further, the male end 16 of each body 12 includes a projection 24 extending circumferentially from the remainder of the arcuate body 12. The male end projection 24 of each arcuate body 12 is sized and shaped to be disposeable within the recess 18 of an adjacent arcuate body 12 to form a joint 15 and couple the arcuate body 12 with the adjacent arcuate body 12.

Furthermore, the female end inner arm 20 of each arcuate body 12 is disposed radially between the shaft outer surface 2 and at least a portion of the male end projection 24 of the adjacent arcuate body 12 when the arcuate body 12 is coupled with the adjacent arcuate body 12. The inner arm 20 of each arcuate body female end 14 is configured to generally prevent radially-inward displacement of the male end 16 of the adjacent arcuate body 12 coupled with the particular arcuate body 12. In other words, due to positioning of and sizing of the inner arm 20, any radially-inward biasing on the male end 16 of an arcuate body 12, such as arising from fluid pressure, inertia and/or spring force on the outer surface of the body 12, is prevented from displacing the male end 16 inwardly toward the shaft outer surface 2. As such, damage or wear on the arcuate body male ends 16, and each adjacent female end 14, caused by contact with the rotating shaft 1, or a sleeve 62 mounted on the shaft 1, is substantially prevented.

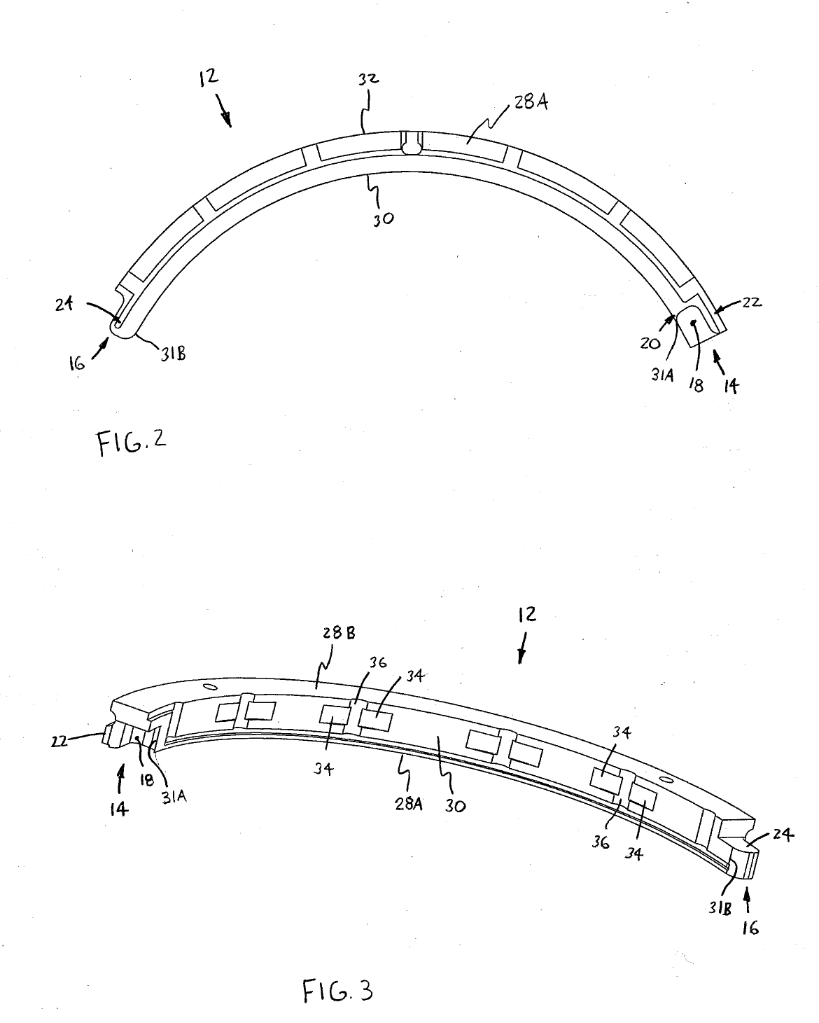

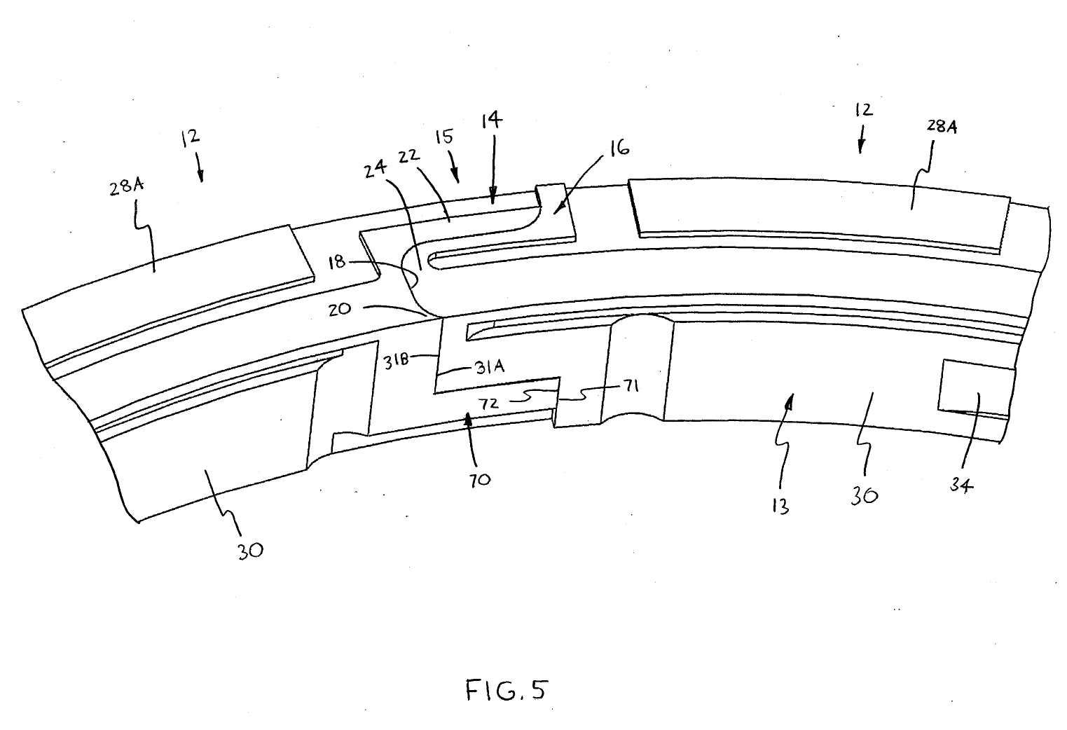

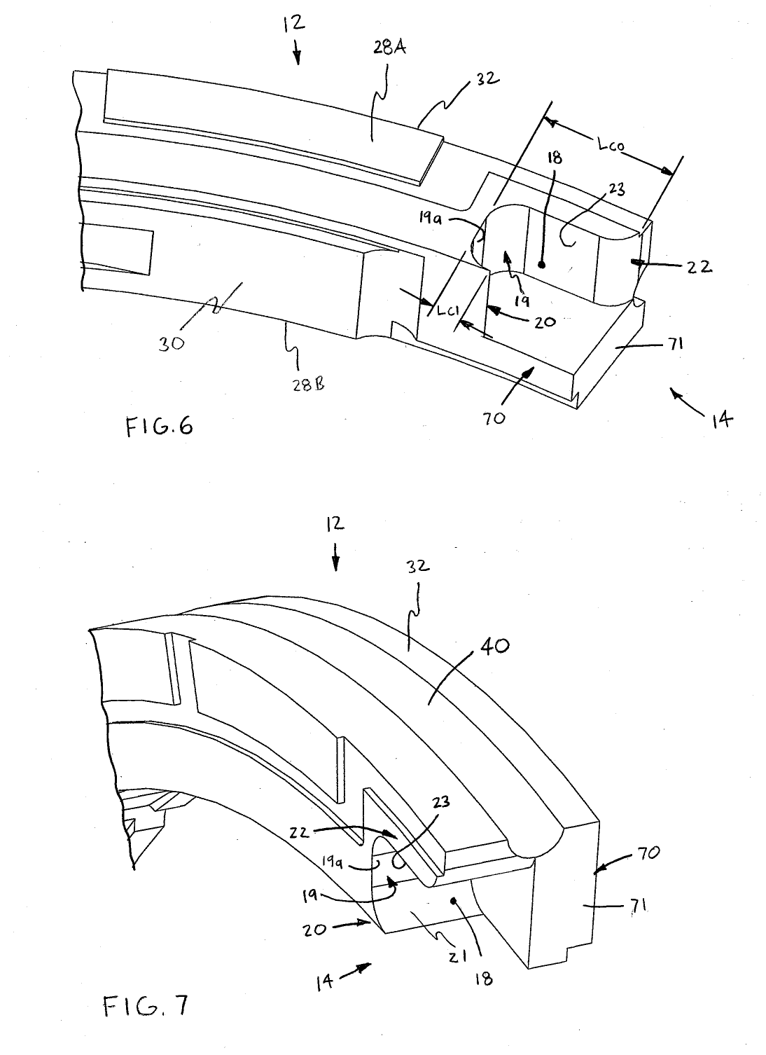

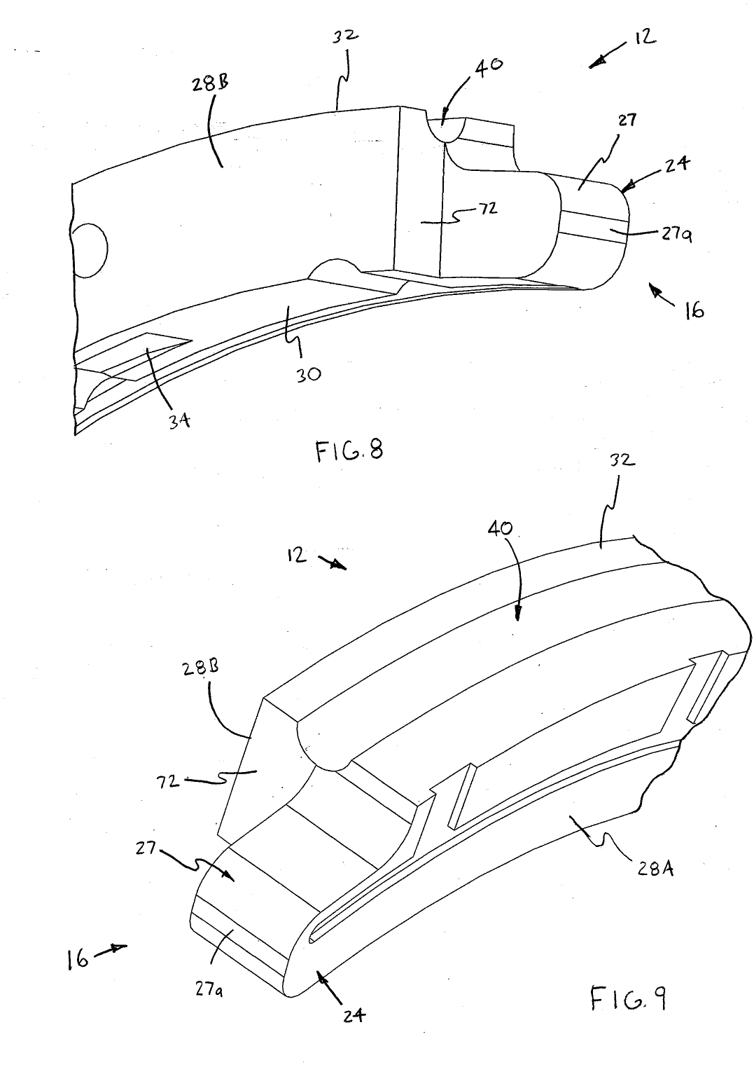

Referring now to FIGS. 2-4, each arcuate body 12 has opposing axial side surfaces 28A, 28B, an inner circumferential sealing surface 30 and an opposing outer circumferential surface 32. Each circumferential surface 30, 32 is disposed between the two side surfaces 28A, 28B and extends between the female and male ends 14, 16, respectively. The body inner surface 30 has a first edge 31A at a free end of the female end inner arm 20 and an opposing second edge 31B spaced circumferentially inwardly from a free end of the male end projection 24. The inner surface second edge 31B of each arcuate body 12 is located substantially adjacent to the inner surface first edge 31A of the adjacent arcuate body 12 when the particular arcuate body 12 is coupled with the adjacent arcuate body 12, as best shown in FIG. 5. As such, a generally continuous sealing surface 13 of the seal assembly 10 is formed collectively by all of the arcuate body inner surfaces 30, as indicated in FIG. 4.

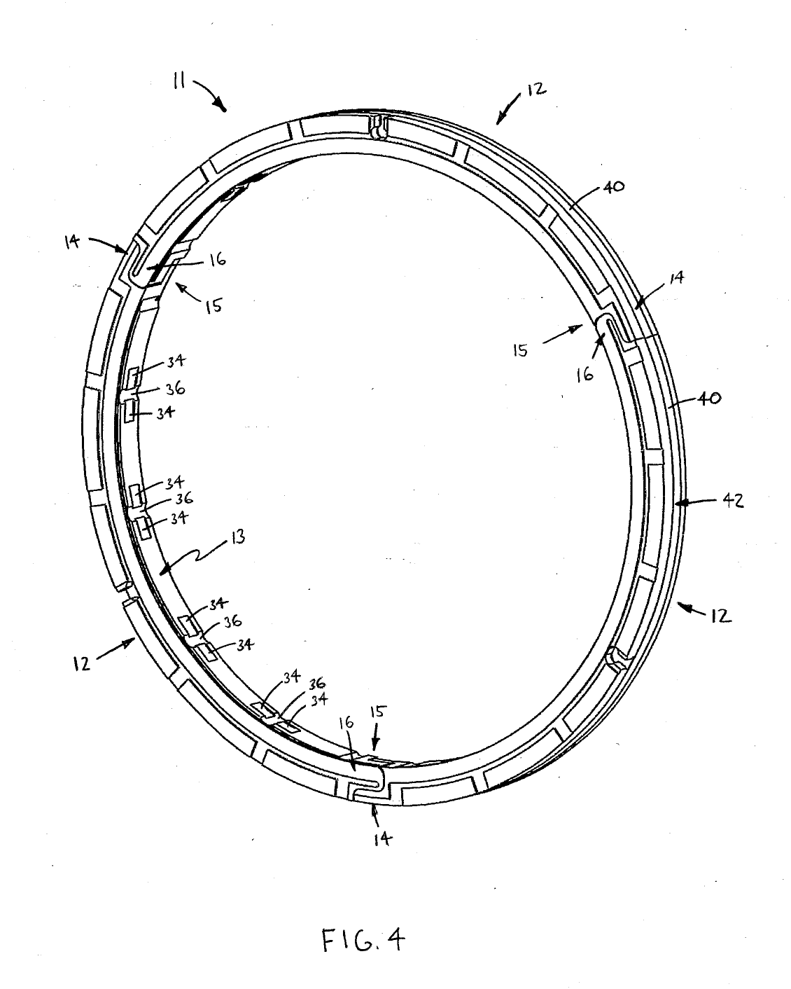

Further, in certain preferred constructions, each arcuate body 12 has at least one and preferably a plurality of lift recesses 34 each extending radially outwardly from the body inner circumferential surface 28, as best shown in FIGS. 2 and 3. Each recess 34 is configured to generate a radially-outwardly directed force to bias the arcuate body 12 from the shaft outer surface 2 during rotation of the shaft 1. More specifically, each arcuate body 12 preferably further has at one bleed slot 36 extending generally axially between the two axial side surfaces 28A, 28B and fluidly coupled with at least one lift recess 34, if uni-directional, or two, generally facing lift recesses 34, if bi-directional. With this structure, a portion of fluid entering through one bleed slot 36 flows into a fluidly coupled recess 34 and exerts pressure on a ramped surface of the recess 34, thereby generating a radially-outwardly directed lift force on the arcuate body 12 that tends to “lift” the arcuate body 12 from the shaft outer surface 2. However, one or more (or all) of the arcuate bodies 12 may be formed without lift recesses, depending on the specific requirements of a particular application of the seal assembly 10.

Referring now to FIGS. 4, 7-9 and 14, each arcuate body 12 preferably further has a generally arcuate groove or groove section 40 extending radially inwardly from the body outer surface 32 and circumferentially between the female and male ends 14, 16, respectively. The groove 40 of each arcuate body 12 is generally circumferentially alignable with the groove 40 of each adjacent arcuate body 12. As such, when all of the bodies 12 of a seal assembly 10 are coupled together, the individual arcuate grooves 40 collectively form a generally continuous annular groove 42 (FIG. 4) of the seal assembly 10. Furthermore, the seal assembly 10 preferably further comprises a generally annular biasing member 44 disposed within the seal assembly continuous groove 42, as depicted in FIGS. 1 and 14. The biasing member 44 is preferably a garter spring and provides a radially-inwardly directed force to both maintain the plurality of arcuate bodies 12 coupled together and to maintain the seal assembly sealing surface 13 in contact with the shaft outer surface 2 when the shaft 1 is a non-rotational or “static” state.

Referring now to FIGS. 1, 13 and 14, in many preferred embodiments, the seal assembly 10 further comprises a housing 50 having an annular interior channel 52 within which is disposed the seal 11. Preferably, the seal assembly 10 includes two seals 11 each disposed within the interior channel 52 and arranged axially adjacent to each other. Further, the housing 50 is preferably formed primarily of a main, generally annular body 54 and a generally L-shaped, annular closure member 56. The housing main body 54 has opposing, first and second axial ends 54a, 54b, an annular chamber 55 extending to the first end 54a and a secondary sealing portion 57. The secondary sealing portion 57 extends axially from the main body second end 54b and is engageable with the shaft 1 to provide a secondary, labyrinth-type seal 58. The closure member 56 is at least partially disposeable within the main body chamber 55 so as to enclose the first end 54a and partially define the sealing channel 52 and is retained within the main body 54 by a generally circular retainer ring 60.

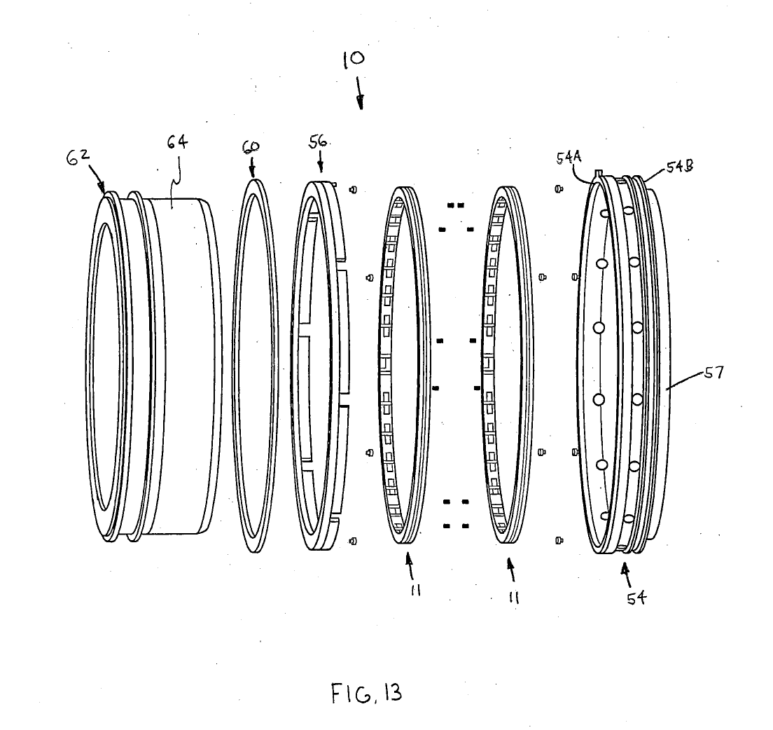

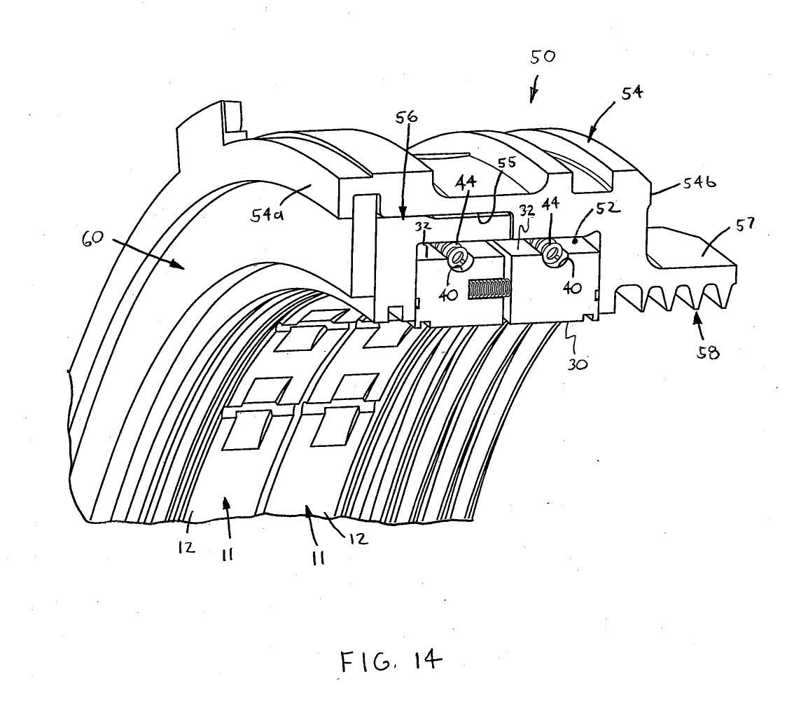

With this structure, the preferred two seals 11 may be assembled within, or removed from, the housing 50 by disassembling the retainer ring 60 and closure member 56 from the housing main body 54. Furthermore, the seal assembly 10 may be used with a generally cylindrical sleeve 62 disposeable about the shaft 1 and coupled therewith so as to rotate with the shaft 1 about the central axis A_{C} (see FIG. 13). The sleeve 62 has an outer circumferential surface 64 sealingly engageable by the seal(s) 11, such that the sleeve 62 functions as an extension of the shaft 1. However, as shown in FIG. 1, the seal assembly 10 may seal directly about the shaft outer surface 2.

It must be noted that structure of the housing 50 as described above is but one possible housing structure and is provided for purposes of illustration only. Thus, the scope of the present invention includes any housing structure, applications in which only a single seal 11 is utilized, and or applications in which the seal assembly 10 is installed directly into a machine without a separate seal housing.

Referring now to FIGS. 3-6, in certain preferred applications, the female end 14 of each arcuate body 12 is preferably formed such that outer arm 22 is substantially longer than the inner arm 20. That is, the outer arm 22 of each arcuate body female end 14 has a circumferential length L_{CO} that is substantially greater than a circumferential length L_{CI} of the inner arm 20 of the arcuate body female end 14, as indicated in FIG. 6. The reason for such relative sizing of the arms 20, 22 is due to one preferred method of forming the arcuate body 12, which is to machine an existing seal body so as to form the inner arm 22. However, the seal arcuate body 12 may be formed with generally equal length inner and outer arms 20, 22, or even with an inner arm 20 longer than the outer arm 22 (no alternatives shown).

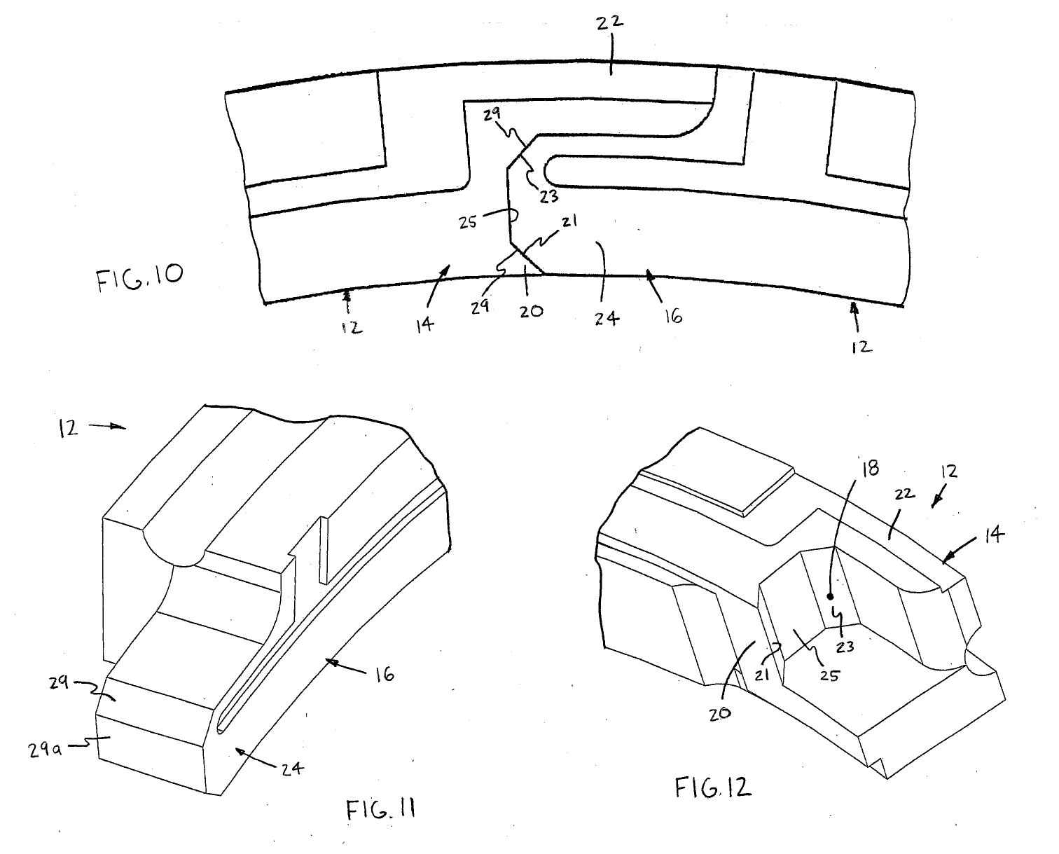

Further, the female end recess 18 of each arcuate body 12 may be defined by an inner surface(s) that are generally curvilinear or generally flat, in either case being shaped to accommodate a complementary-shaped male end 16 of an adjacent arcuate body 12. More specifically, in certain applications as best depicted in FIGS. 6 and 7, the female end recess 18 of each arcuate body 12 has a generally concave curved inner surface 19 partially defined by and extending between an inner surface section 21 of the inner arm 20 and an inner surface section 23 of the outer arm 22. In such applications, the male end projection 24 of each arcuate body 12 has a generally convex curved outer surface 27 sized to be disposed against the female end concave surface 19 of an adjacent arcuate body 12, to generally interlock the two bodies 12, as shown in FIGS. 8 and 9. Although described as generally curved, each surface 19, 27 may have one or more generally flat sections 19a, 27a, respectively, as indicated in FIGS. 6-9.

In other applications, one example being shown in FIGS. 10-12, the female end recess 18 may be defined by two or more generally flat inner surface sections, such that the recess may be generally triangular, generally square, partially octagonal (as shown), etc. (no other alternatives depicted). More specifically, the recess 18 may be defined by the inner surfaces 21, 23 of the two arms 20, 22, which are generally facing each other and spaced apart or/and converging, and the recess 18 may further include one or more additional generally flat surface sections 25 between the inner and outer arm surface sections 21, 23. In such applications, the male end projection 24 of each arcuate body 12 has at least two, opposing outer surfaces 29 each disposable against a separate one of the arm inner surfaces 21, 23 of the female end 14, and possibly a flattened end surface 29a disposable against the one or more additional flat surfaces 25, of an adjacent arcuate body 12.

Referring to FIGS. 5-9, the female end 14 of each seal arcuate body 12 is preferably formed such that the inner and outer arms 20, 22 extend axially across only a portion of the width of the arcuate body 12. As such, each body female end 14 further has a sidewall portion 70 adjacent to and bounding one axial side of the recess 18, the sidewall portion 70 having a circumferential end surface 71. Also, the male end 16 of each arcuate body 12 is preferably correspondingly formed such that the projection 24 extends axially across only a portion of the width of the arcuate body 12, so that a circumferential end surface 72 is defined on the body 12 adjacent to the projection 24. With this structure, the female end sidewall portion 70 of each arcuate body 12 axially overlaps the male end projection 24 of the adjacent body 12, with the female end sidewall end surface 71 being disposed generally against the male end circumferential end surface 72. Such overlapping of the sidewall portion 70 and projection 18 provides each joint 15 with lateral support and helps to minimize fluid flow axially through the joint 15.

Although the female and male ends 14, 16 of each arcuate body 12 are preferably formed as described above, i.e., with the female end sidewall portion 70 overlapping the male end projection 24, the bodies 12 may alternatively be formed with female end arms 20, 22 (and thus recesses 18) and the male end projections 24 extending across the entire axial width of each body 12. As a further alternative, each female end 14 may have two sidewall portions on each side of the recess, with the male end projection being centered between two circumferential end surfaces (structure not shown). The present invention includes the structures of the female and male ends 14, 16 as described and depicted herein and any other structure of a seal arcuate body 12 having at least one female end inner arm 20 configured to prevent inward radial displacement of the male end 16 of an adjacent arcuate body 12.

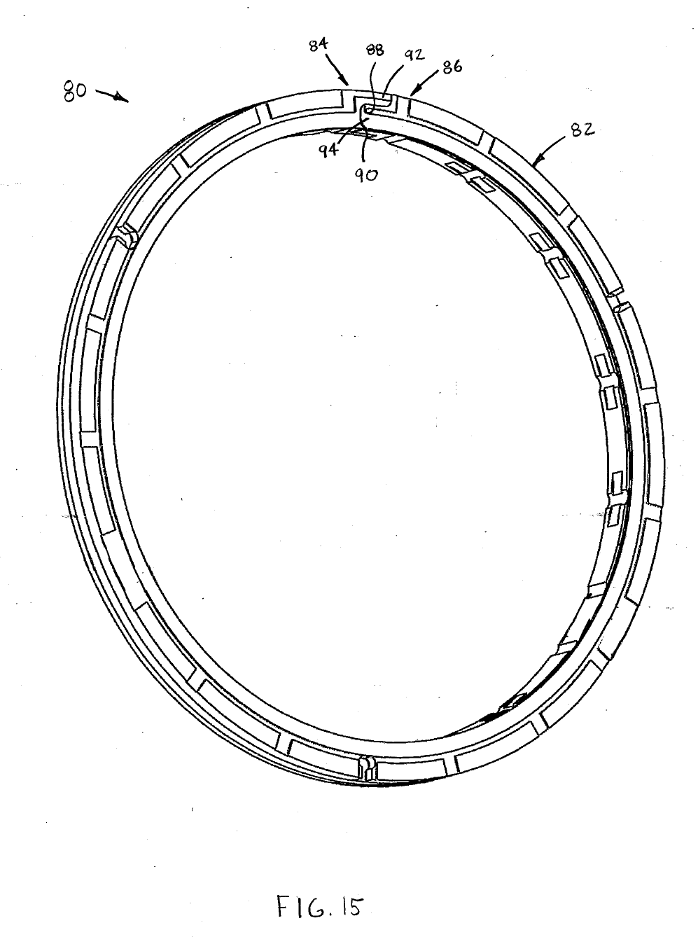

Referring now to FIG. 15, in an alternative construction, a seal assembly 80 includes only a single, generally annular body 82 having female and male circumferential ends 84, 86 coupleable together to form a generally continuous seal body 83. The female end 84 includes a recess 88 defined at least partially by a radially-inner arm 90 and a radially-outer arm 92 each extending generally circumferentially from a remainder of the arcuate body 82. The male end 86 includes a projection 94 extending circumferentially from the remainder of the arcuate body 82 and sized to be disposeable within the female end recess 88 to couple the body ends 84, 86. As with the first preferred embodiment, the female end inner arm 90 is disposed radially between the shaft outer surface (shaft not depicted) and at least a portion of the male end projection 94 when the two body ends 84, 86 are coupled together such that the inner arm 90 is configured to generally prevent radially-inward displacement of the male end 86.

Such a seal assembly 80 is formed generally similar to the seal assembly 10 as described above, i.e., with one or more lift-recesses 34, an outer annular groove and biasing member, a housing 50, etc., other than being formed of only a single annular body 82. Such a body 80 may be fabricated by forming a solid ring with all the structural features described above and then machining or otherwise forming a separation in the body 82 to provide the female and male ends 84, 86.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A circumferential shaft seal assembly for sealing about a shaft rotatable about a central axis, the shaft having an outer circumferential surface, the seal assembly comprising:
at least two generally arcuate bodies coupleable together to form a generally annular seal disposeable about the shaft outer surface, each arcuate body having opposing female and male circumferential ends, each female end including a recess defined at least partially by a radially-inner arm and a radially-outer arm each extending generally circumferentially from a remainder of the arcuate body, each male end including a projection extending circumferentially from the remainder of the arcuate body and sized to be disposeable within the recess of an adjacent arcuate body to couple the arcuate body with the adjacent arcuate body, the female end inner arm of each arcuate body being disposed radially between the shaft outer surface and at least a portion of the male end projection of the adjacent arcuate body when the arcuate body is coupled with the adjacent arcuate body;
wherein each arcuate body has at least one lift recess extending radially outwardly from the body inner circumferential surface and configured to generate a radially outwardly directed force to bias the arcuate body from the shaft outer surface during rotation of the shaft and the inner arm of each arcuate body female end is configured to generally prevent radially-inward displacement of the male end of the adjacent arcuate body coupled with the arcuate body toward the outer surface of the shaft during rotation.

2. (canceled)

3. The seal assembly as recited in claim 1 wherein each arcuate body has an inner circumferential sealing surface extending between the female and male ends and having a first edge at a free end of the female end inner arm and an opposing second edge spaced circumferentially inwardly from a free end of the male end projection, the second edge of the inner surface of each arcuate body being located substantially adjacent to the first edge of the inner surface of the adjacent arcuate body when the arcuate body is coupled with the adjacent arcuate body so as to form a generally continuous sealing surface of the seal assembly.

4. (canceled)

5. The seal assembly as recited in claim 1 wherein each arcuate body has two, opposing axial side surfaces and at least one slot extending generally axially between the two axial side surfaces and fluidly coupled with the at least one lift recess.

6. The seal assembly as recited in claim 1:
wherein each arcuate body has an outer circumferential surface and a generally annular groove extending radially inwardly from the outer surface and circumferentially between the male and female ends, the groove of each arcuate body being generally circumferentially aligned with the groove of each adjacent arcuate body so as to form a generally continuous annular groove of the seal assembly; and
the seal assembly further comprises a generally annular biasing member disposed within the seal assembly continuous groove.

7. The seal assembly as recited in claim 1 wherein the outer arm of each arcuate body female end has a circumferential length that is substantially greater than a circumferential length of the inner arm of the arcuate body female end.

8. The seal assembly as recited in claim 1 wherein one of:
the female end of each arcuate body has a concave surface partially defined by and extending between an inner surface section of the outer arm and an inner surface section of the inner arm and the male end projection of each arcuate body has a convex surface sized to be disposed against the female end concave surface of an adjacent arcuate body; and
the female end inner arm of each arcuate body has an inner surface, the female end outer arm of each arcuate body has an inner surface spaced from and facing generally toward the inner arm inner surface, the two arm inner surfaces at least partially defining the recess, and the male end projection of each arcuate body has two, opposing outer surfaces each disposable against a separate one of the female end arm inner surfaces of an adjacent arcuate body.

9. The seal assembly as recited in claim 1 wherein each seal body is formed of at least one of carbon, carbon graphite, ceramic, a ceramic-carbon mixture, a polymer and a ferrous metal.

10. A circumferential shaft seal assembly for sealing about a shaft rotatable about a central axis, the shaft having an outer circumferential surface extending about the axis, the seal assembly comprising:
a plurality of generally arcuate bodies spaced circumferentially about the shaft axis and coupled together to form a generally annular seal disposed about the shaft outer surface, each arcuate body having opposing female and male circumferential ends and an inner circumferential surface extending between the male and female ends, each female end including a recess defined at least partially by a radially-inner arm and a radially-outer arm each extending generally circumferentially from a remainder of the arcuate body, each male end including a projection extending circumferentially from the remainder of the arcuate body and sized to be disposed within the recess of an adjacent arcuate body to couple the arcuate body with the adjacent arcuate body, the female end inner arm of each arcuate body being disposed radially between the shaft outer surface and at least a portion of the male end projection of the adjacent arcuate body when the arcuate body is coupled with the adjacent arcuate body;
wherein each arcuate body has at least one lift recess extending radially outwardly from the body inner circumferential surface and configured to generate a radially outwardly directed force to bias the arcuate body from the shaft outer surface during rotation of the shaft and the inner arm of each arcuate body female end is configured to generally prevent radially-inward displacement of the male end of the adjacent arcuate body coupled with the arcuate body toward the outer surface of the shaft during rotation.

11. (canceled)
